(19) United States
(12) Patent Application Publication
(10) Pub. No.: US 2007/0298386 A1
(43) Pub. Date: Dec. 27, 2007

(54) Character Learning Apparatus and Driving Method Thereof for Preschool Child

(76) Inventor: Min Han Kim, Incheon (KR)

Correspondence Address: IPLA P.A., 3580 WILSHIRE BLVD., 17TH FLOOR, LOS ANGELES, CA, 90010, US

(21) Appl. No.: 11/813,409

(22) PCT Filed: Jan. 4, 2006
(86) PCT No.: PCT/KR06/00009

§ 371 Date: Jul. 5, 2007

(30) Foreign Application Priority Data
Jan. 5, 2005 (KR) 10-2005-0001010

(51) Int. Cl. G09B 5/06

(52) U.S. Cl. 434/159

(57) ABSTRACT

A character learning apparatus for preschool children and a method for driving the same are disclosed. The apparatus can be easily handle by preschool children. The apparatus originally prevents breakdown sources due to electrically bad contact because the apparatus does not need electrical contact to install elements thereto. For this, the character learning apparatus for preschool children comprising: more than one character input boards which are implemented with rectangular plates on which characters, figures are perforated, respectively; a body having a groove to which the character input boards are buriedly inserted; a piezoelectric device group which are adjacently aligned and coupled to each other in a predetermined area on the bottom side of the groove of the body; a central processing unit which operates electrical signals inputted from piezoelectric devices in the piezoelectric device group and converts the operated signals to character and voice signals to be outputted; speakers outputting voices corresponding to the signals outputted from the central processing unit thereto; a cover having a hinge to cover the body; and a display unit which is implemented with a flat member which displays images corresponding to signals outputted from the central processing unit and which is installed inside the cover.

### TECHNICAL FIELD

The present invention relates to a character learning technology for preschool children, and more particularly to a character learning apparatus for preschool children and a method for driving the same, which are capable of making the preschool children rewrite characters/figures, etc. outputted to a base screen, such that the preschool children can easily learn the characters/figures, etc. and correct their fonts.

### BACKGROUND ART

In general, study books are used as character learning tools for an infant and a preschool child. The study books are used as the infant and the preschool child rewrite characters which are printed thereon, using writing tools, such as a pencil.

However, the study books are difficult for the infant and preschool child to learn characters because they must rewrite the characters printed on the study books and must be simultaneously taught by other people. Therefore, in order to resolve such a problem, a plate for learning characters has been developed. Here, the plate is formed such that grooves shaped as characters are perforated with a predetermined depth on the plate and the bottom surface of the perforated grooves forms a plurality of protrusions, which are spaced apart from each other with a predetermined distance thereon, such that users can feel when they rewrite corresponding characters.

But, the prior art plate for learning characters must need a teacher or parents in order to correctly teach the infant and preschool child meaning of corresponding characters, pronunciation and stroke order, etc. Furthermore, since the prior art plate makes the user rewrite with only their fingers, it is difficult to induce interest to character learning and to correct their fonts.

As shown in FIG. 1 and FIG. 2, Korean Patent Application No. 10-2002-0009569 discloses a character learning apparatus 100. The character learning apparatus 100 includes a body, a character input board 20 installed to the body, a sub-body 40 in which a monitor 10 is installed, in which the monitor displays images corresponding to characters which are inputted through the character input board 20, a controller 102, a voice processing unit 104, a monitor driving unit 106, a memory unit 108, a power supply 110, a light emitting unit 112, a speaker 30, a monitor 10, and a character input board mounting unit 80.

On the other hand, the operation method of the prior art character learning apparatus 100 includes the steps of: detecting that the character input board is inserted to the character input board mounting unit, determining types of the inserted character input boards, detecting characters inputted from the inserted character input board, displaying images corresponding the detected character on the monitor, and outputting voice corresponding to the detected character through the speaker.

Since the prior art character learning apparatus and the prior art character learning method output voices for meanings and precise pronunciation of characters and automatically check learning accomplishment, they do not need an additional guidance teacher, such as a teacher, parents, etc., rather induce interests that a preschool child wish to learn characters.

However, the prior art character learning apparatus has disadvantages in that, since the prior art character learning apparatus must include relatively expensive character input boards 20 such that they can be exchangeably installed thereto according to kinds of characters, its price is high. Also, since the character learning apparatus is implemented to have a structure such that the character input board must be electrically connected to the character learning apparatus when the character input board is replaced with another, if such electrical connection therebetween are not proper, the character learning apparatus can be easily broken down. In addition, the prior art character learning apparatus has a drawback in that the prior art character input board 20 cannot be easily handled by the preschool children.

### DISCLOSURE OF INVENTION

### Technical Problem

Therefore, the present invention has been made in view of the above problems, and it is an object of the present invention to provide a character learning apparatus for preschool child and a method for driving the same, which are capable of inducing learning interest for preschool children, and of assisting preschool children to learn various characters (Hangeul, or Korean, and English alphabets, etc.) or figures, and which have general operation functions such that the preschool children can develop their mathematical principle.

It is another object of the present invention to provide a character learning apparatus for preschool child, which includes a plate in which characters are perforated, such that preschool children can easily handle it, and which originally prevents breakdown sources due to electrically bad contact because the apparatus does not need electrical contact to install elements thereto.

### Technical Solution

In accordance with an aspect of the present invention, the above and other objects can be accomplished by the provision of a character learning apparatus for preschool children comprising: more than one character input boards which are implemented with rectangular plates on which characters, figures are perforated, respectively; a body having a groove to which the character input boards are buriedly inserted; a piezoelectric device group which are adjacently aligned and coupled to each other in a predetermined area on the bottom side of the groove of the body; a central processing unit which operates electrical signals inputted from piezoelectric devices in the piezoelectric device group and converts the operated signals to character and voice signals to be outputted; speakers outputting voices corresponding to the signals outputted from the central processing unit thereto; a cover having a hinge to cover the body; and a display unit which is implemented with a flat member which displays images corresponding to signals outputted from the central processing unit and which is installed inside the cover.

Preferably, the apparatus may further include a supporter supporting the character input board, which is installed along the edge of the groove of the body, such that the character input board itself cannot press the piezoelectric devices.

Preferably, the character input boards includes a Korean character plate on which Korean consonants and vowels are perforated.

Preferably, the character input boards may include an English character plate on which English alphabet consonants and vowels are perforated.

Preferably, the character input boards may include a figure operation plate on which figure holes and operation holes are perforated, wherein the figures holes and the operation holes are grouped on the figure/operation plate.

Preferably, the character input board may include an operation plate in which a form member group and an operation member group are divided and formed, wherein the form member group is constructed such that form members for various animal/fruits/flowers are movably inserted to corresponding holes and coupled to each other, and the operation member group is constructed such that operation members are movably inserted to corresponding holes and coupled to each other.

In accordance with another aspect of the present invention, there is provided a method for driving a character learning apparatus for preschool children comprising the steps of: initializing all registers; based on a character input board which is selected among from various character input boards and which is buriedly inserted to the groove of the body, when a hole of the character input board is partially pressed, inputting an electric signal value which is generated by a corresponding piezoelectric device in the piezoelectric device group, and operating values (character values/figure values/operation values/voice values) corresponding to the electric signal value; and outputting the values (character values/figure values/operation values/voice values) to a display unit and/or speakers.

Preferably, the operation step includes the steps of: 1) determining as to whether a selected character input board is a Korean alphabet plate; 2) if the determination of step a) is positive, storing a value initially inputted from the piezoelectric device group in a register ‘a1’; 3) loading a predetermined value (character value/voice value) corresponding to the value stored in the register ‘a1’ and then storing it in a register ‘a2’; 4) comparing the magnitude of the value stored in register ‘a1’ with that of the value stored in register ‘a2’ and then determining as to whether the comparison value exceeds a limit of error; 5) if the determination of step 4) is positive, outputting corresponding character value and voice value to the display unit and the speakers, respectively, and, if the determination of step 4) is negative, loading a predetermined value for a commercialized voice corresponding to a word of praise and then outputting to the speakers; 6) determining as to whether a second value is inputted from the piezoelectric device group; 7) if the determination of step 6) is positive, storing the second value in a register ‘b1’; 8) determining as to whether the value stored in the register ‘b1’ is in a group in which a value stored in the register ‘a1’ is stored; 9) if the determination of step 8) is negative, loading a predetermined value (character value/voice value) corresponding to the register ‘b1’ and then storing it in a register ‘b2’; 10) comparing the magnitude of the value stored in the register ‘b1’ with that of the value stored in the register ‘b2’ and then determining as to whether the comparison value exceeds a limit of error; 11) if the determination of step 10) is positive, outputting corresponding character value and voice value to the display unit and the speakers, respectively, and, if the determination of step 10) is negative, loading a predetermined value for a commercialized voice corresponding to a word of praise and then outputting it to the speakers; 12) determining as to whether a third value is inputted from the piezoelectric device group; 13) if the determination of step 12) is positive, storing the third value in a register ‘c1’; 14) determining as to whether the value stored in the register ‘c1’ is in a group in which a value stored in the register ‘b1’ is stored; 15) if the determination of step 14) is negative, loading a predetermined value (character value/voice value) corresponding to the register ‘c1’ and then storing it in a register ‘c2’; 16) comparing the magnitude of the value stored in the register ‘c1’ with that of the value stored in the register ‘c2’ and then determining as to whether the comparison value exceeds a limit of error; 17) if the determination of step 16) is positive, outputting corresponding character value and voice value to the display unit and the speakers, respectively, outputting operation values to the display unit and the speakers, respectively, and, if the determination of step 16) is negative, loading a predetermined value for a commercialized voice corresponding to a word of praise and then outputting it to the speakers; 18), based on the determination as to whether a selected character input board is a Korean alphabet plate in step of 1), if the determination of step 1) is negative, further performing a determination as to whether the selected character input board is English alphabet plate; 19) if the determination of step 18 is positive, returning the procedure to the step of 2), such that a value initially inputted from the piezoelectric device group is stored in a register ‘a1’; 20) if the determination of step 18) is negative, further performing a determination as to whether the selected character input board is a figure/operation plate; 21) if the determination of step 20) is positive, returning the procedure to step 2), such that a value initially inputted from the piezoelectric device group is stored in a register ‘a1’; 22) if the determination of step 20) is negative, further performing a determination as to whether the selected character input board is an operation plate; 23) if the determination of step 22) is positive, returning the procedure to step 2), such that a value initially inputted from the piezoelectric device group is stored in a register ‘a1’; and 24) if the determination of step 22) is negative, returning the procedure to step 1).

### ADVANTAGEOUS EFFECTS

structured such that various types of character input boards are electrically assembled, since the character learning apparatus for preschool children according to the present invention is configured such that only plates in which characters are perforated are included, infants and preschool children can easily handle it. Also, the character learning apparatus for preschool children according to the present invention can originally prevent breakdown sources due to electrically bad contact because the apparatus does not need electrical contact to install elements thereto.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of the prior art character learning apparatus;

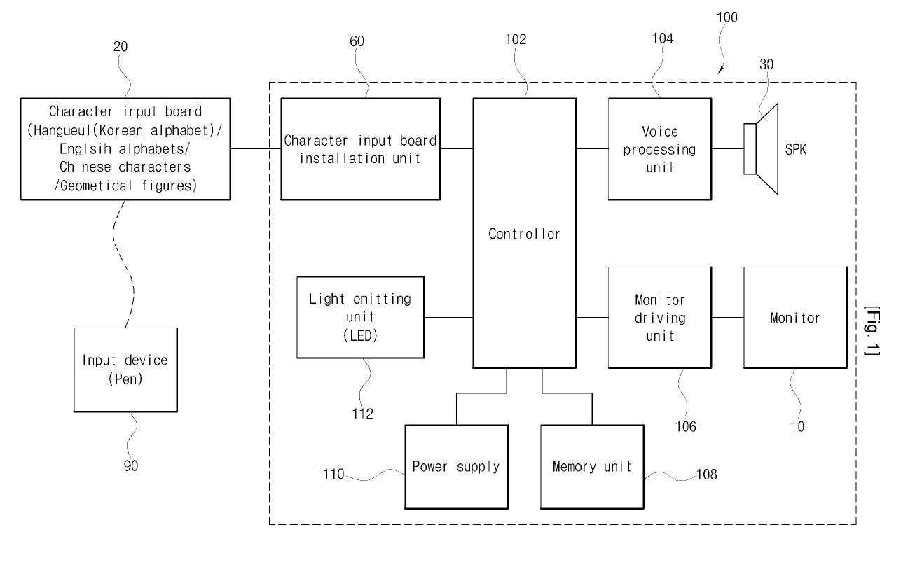

FIG. 2 is a perspective view of the prior art character learning apparatus;

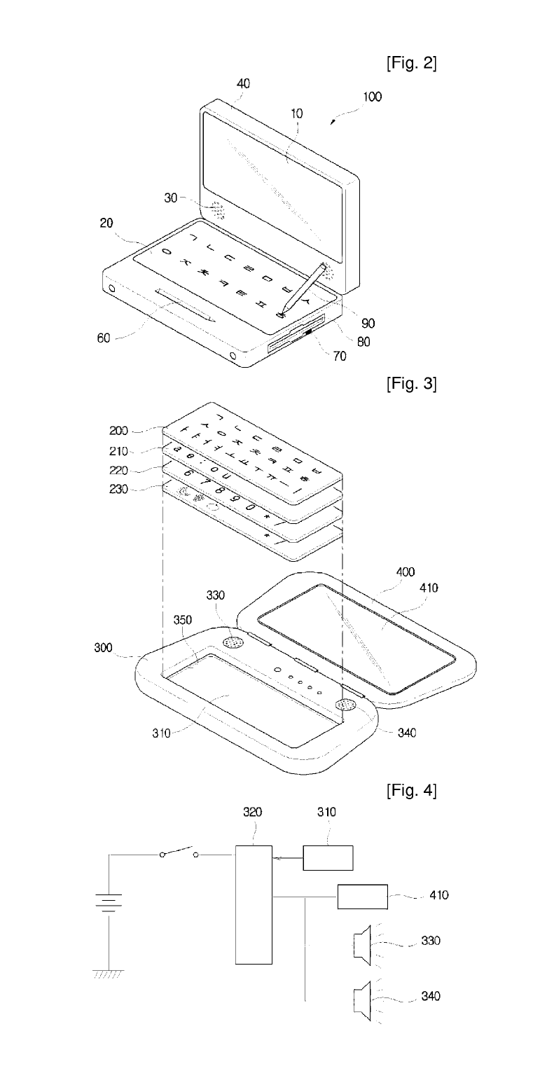

FIG. 3 is a perspective view of a character learning apparatus according to the present invention;

FIG. 4 is a schematic block diagram of a characteristic learning apparatus according to the present invention; and

FIG. 5a to FIG. 5c are flow charts describing a method for driving a character learning apparatus according to the present invention.

### BEST MODE FOR CARRYING OUT THE INVENTION

With reference to the attached drawings, preferred embodiments according to the present invention are described in detail below.

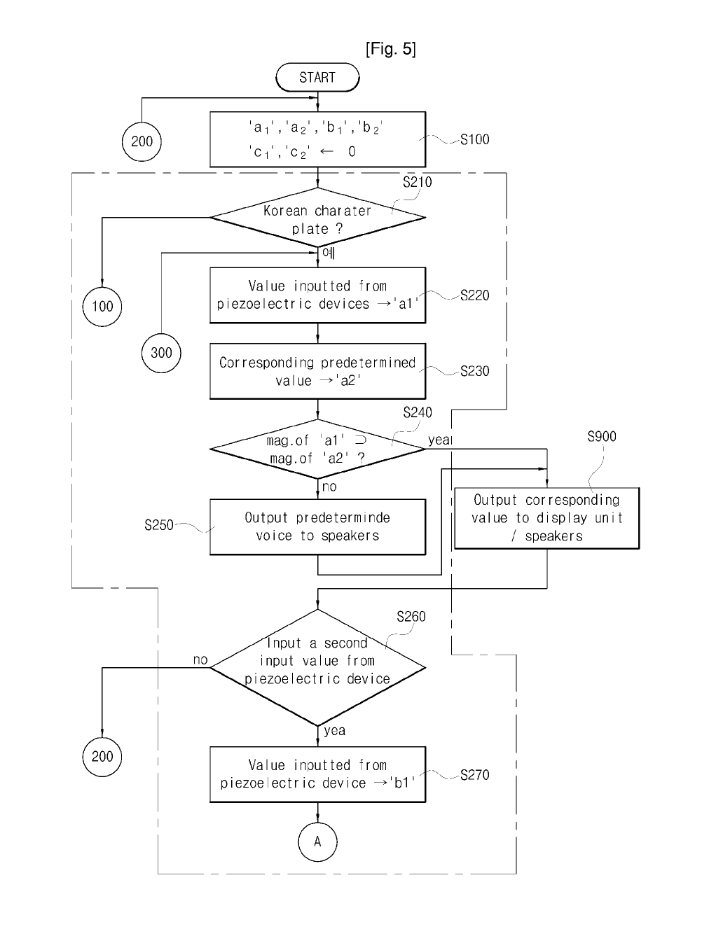

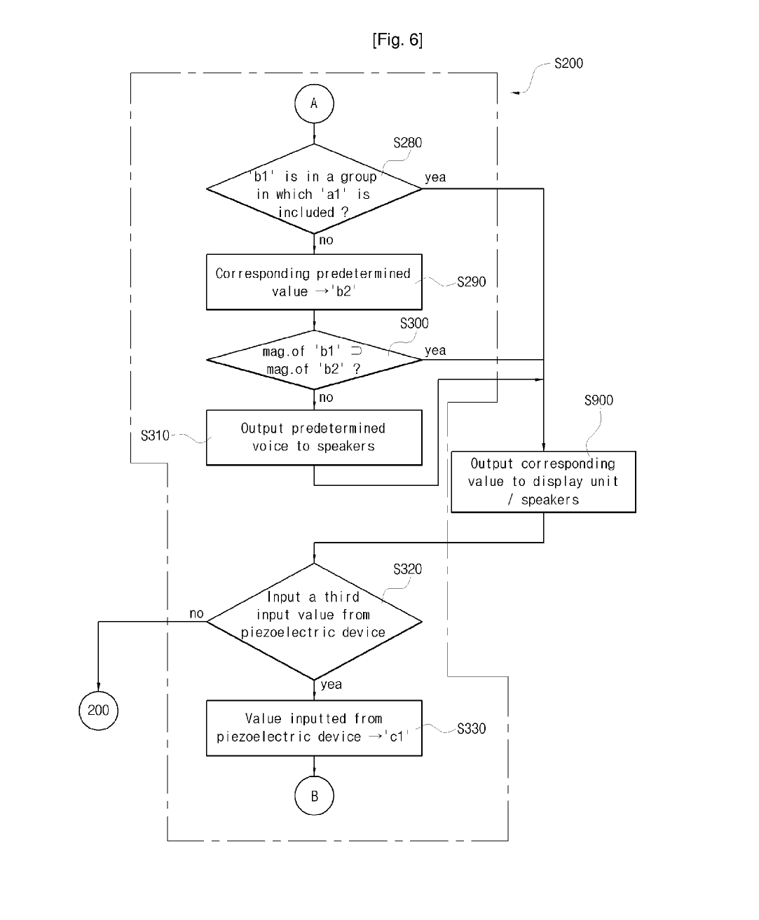

As shown in FIG. 3 and FIG. 4, a character learning apparatus according to the present invention includes more than one character input boards, a body 300, a group of piezoelectric devices 310, a central processing unit 320, speakers 330 and 340, a cover 400 and a display unit 410.

The more than one character input boards are implemented with respective rectangular plates on which characters, such as Hangeul (Korean alphabets), English alphabets, figures or animals/fruits/flowers, are perforated.

Namely, the character input boards includes a Korean character plate 200 on which Korean consonants and vowels are perforated, an English character plate 210 on which English alphabet consonants and vowels are perforated, or a figure/operation plate 220 on which figure holes and operation holes are perforated. Here, the figures holes and the operation holes are grouped on the figure/operation plate.

Also, the character input boards further include an operation plate 230 in which a form member group and an operation member group are divided and formed. Here, the form member group is constructed such that form members for various animal/fruits/flowers are movably inserted to corresponding holes and coupled to each other.

Also, the operation member group is constructed such that operation members are movably inserted to corresponding holes and coupled to each other.

One selected from among the character input boards is coupled to a groove of the body 300 in a state where the selected character input board is buried in the groove. On the other hand, a plurality of piezoelectric devices 310 are adjacently aligned and coupled to each other in a predetermined area on the bottom side of the groove of the body 300. Therefore, when portions through respective holes of the character input board are pressed, electrical signal values can be outputted from corresponding portions of the piezoelectric devices 310, respectively.

Such electric signals are inputted to the central processing unit 320 such that they can be operated and then converted to characters and voice. The characters and voices are outputted to the display unit 410 and speakers 330 and 340. The display unit 410 is implemented a flat member which displays images corresponding to signals outputted from the central processing unit 320 and which is installed inside the cover 400 having a hinge to cover the body.

On the other hand, a supporter 350 supporting the character input board may be further installed along the edge of the groove of the body 300, such that the character input board itself cannot press the piezoelectric devices 310.

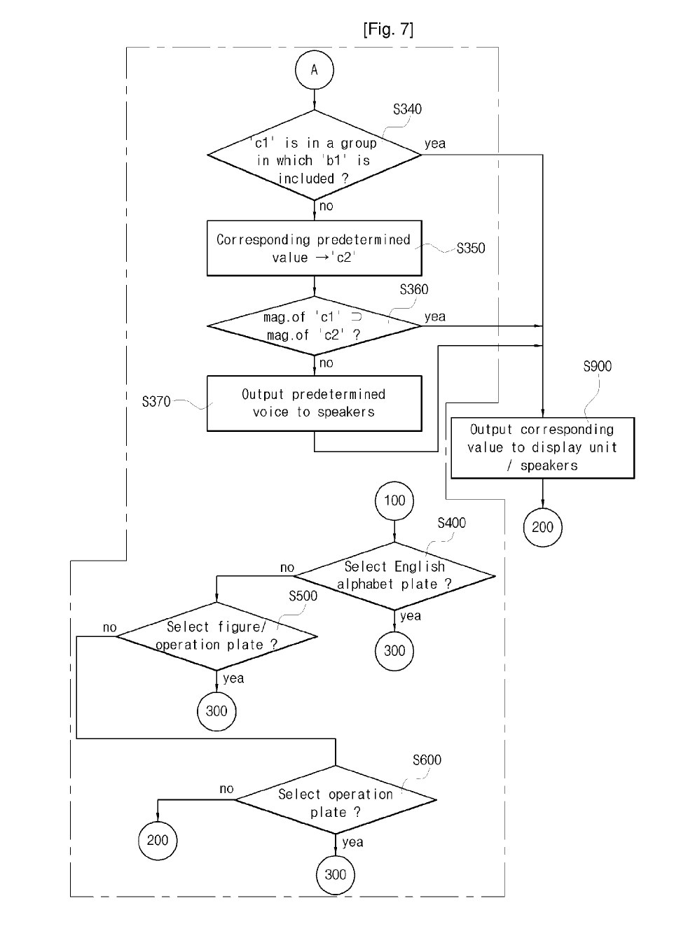

As shown in FIG. 5a to FIG. 5c, a method for driving a character learning apparatus according to the present invention includes is performed as follows: Firstly, all registers are initialized in step S100. Based on a character input board which is selected among from various character input boards and which is buriedly inserted to the groove of the body, when a hole of the character input board is partially pressed, a corresponding piezoelectric device in the piezoelectric device group generates an electric signal value and then values (character values/figure values/operation values/voice values) corresponding to the electric signal value are operated in step S200. Afterwards the values (character values/figure values/operation values/voice values) obtained in operation step of S200 are outputted the display unit and/or the speakers in step S900.

Here, the operation step (S200) is performed as follows:

A determination is made as to whether a selected character input board is a Korean alphabet plate in step S210. If the determination of step S210 is positive, a value initially inputted from the piezoelectric device group is stored in a register ‘a1’ in step S220. After that, a predetermined value (character value/voice value) corresponding to the value stored in the register ‘a1’ is loaded and then stored in a register ‘a2’ in step S230. The magnitude of the value stored in register ‘a1’ is compared with that of the value stored in register ‘a2’ and then a determination is made as to whether the comparison value exceeds a limit of error in step S240. If the determination of step S240 is positive, corresponding character value and voice value are outputted to the display unit and the speakers, respectively, in step S900. On the other hand, if the determination of step S240 is negative, a predetermined value for a commercialized voice corresponding to a word of praise is loaded and then outputted to the speakers in step S250.

Afterwards, a determination is made as to whether a second value is inputted from the piezoelectric device group in step S260. If the determination of step S260 is positive, the second value is stored in a register ‘b1’ in step S270. After that, a determination is made as to whether the value stored in the register ‘b1’ is in a group in which a value stored in the register ‘a1’ is stored in step S280. If the determination of step S280 is negative, a predetermined value (character value/voice value) corresponding to the register ‘b1’ is loaded and then stored in a register ‘b2’ in step S290.

After that, the magnitude of the value stored in the register ‘b1’ is compared with that of the value stored in the register ‘b2’ and then a determination is made as to whether the comparison value exceeds a limit of error in step S300. If the determination of step S300 is positive, corresponding character value and voice value are outputted to the display unit and the speakers, respectively, in step S900. On the other hand, if the determination of step S300 is negative, a predetermined value for a commercialized voice corresponding to a word of praise is loaded and then outputted to the speakers in step in step S310.

After that, a determination is made as to whether a third value is inputted from the piezoelectric device group in step S320. If the determination of step S320 is positive, the third value is stored in a register ‘c1’ in step S330. After that, a determination is made as to whether the value stored in the register ‘c1’ is in a group in which a value stored in the register ‘b1’ is stored in step S340. If the determination of step S340 is negative, a predetermined value (character value/voice value) corresponding to the register ‘c1’ is loaded and then stored in a register ‘c2’ in step S350. After that, the magnitude of the value stored in the register ‘c1’ is compared with that of the value stored in the register ‘c2’ and then a determination is made as to whether the comparison value exceeds a limit of error in step S360. If the determination of step S360 is positive, corresponding character value and voice value are outputted to the display unit and the speakers, respectively, and operation values are outputted to the display unit and the speakers, respectively, in step S900. On the other hand, if the determination of step S360 is negative, a predetermined value for a commercialized voice corresponding to a word of praise is loaded and then outputted to the speakers in step in step S370.

On the other hand, based on the determination as to whether a selected character input board is a Korean alphabet plate in step S210, if the determination of step S210 is negative, a determination is further performed as to whether the selected character input board is English alphabet plate in step S400. If the determination of step S400 is positive, the procedure is returned to step S220, such that a value initially inputted from the piezoelectric device group is stored in a register ‘a1’.

On the other hand, if the determination of step S400 is negative, a determination is further performed as to whether the selected character input board is a figure/operation plate in step S500. If the determination of step S500 is positive, the procedure is returned to step S220, such that a value initially inputted from the piezoelectric device group is stored in a register ‘a1’.

On the other hand, if the determination of step S500 is negative, a determination is further performed as to whether the selected character input board is an operation plate in step S600. If the determination of step S600 is positive, the procedure is returned to step S220, such that a value initially inputted from the piezoelectric device group is stored in a register ‘a1’. On the other hand, if the determination of step S600 is negative, the procedure is returned to step S100.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A character learning apparatus for preschool children comprising:
more than one character input boards which are implemented with rectangular plates on which characters, figures are perforated, respectively;
a body having a groove to which the character input board is buriedly inserted;
a piezoelectric device group which are adjacently aligned and coupled to each other in a predetermined area on the bottom side of the groove of the body;
a central processing unit which operates electrical signals inputted from piezoelectric devices in the piezoelectric device group and converts the operated signals to character and voice signals to be outputted;
speakers outputting voices corresponding to the signals outputted from the central processing unit thereto;
a cover having a hinge to cover the body; and
a display unit which is implemented with a flat member which displays images corresponding to signals outputted from the central processing unit and which is installed inside the cover.

2. The apparatus as set forth in claim 1, further comprising:
a supporter supporting the character input board, which is installed along the edge of the groove of the body, such that the character input board itself cannot press the piezoelectric devices.

3. The apparatus as set forth in claim 1 or 2, wherein the character input boards includes a Korean character plate on which Korean consonants and vowels are perforated.

4. The apparatus as set forth in claim 1 or 2, wherein the character input boards includes an English character plate on which English alphabet consonants and vowels are perforated.

5. The apparatus as set forth in claim 1 or 2, wherein the character input boards includes a figure operation plate on which figure holes and operation holes are perforated, wherein the figures holes and the operation holes are grouped on the figure/operation plate.

6. The apparatus as set forth in claim 1 or 2, wherein the character input board includes an operation plate in which a form member group and an operation member group are divided and formed, wherein the form member group is constructed such that form members for various animal/fruits/flowers are movably inserted to corresponding holes and coupled to each other, and the operation member group is constructed such that operation members are movably inserted to corresponding holes and coupled to each other.

7. A method for driving a character learning apparatus for preschool children comprising the steps of:
initializing all registers;
based on a character input board which is selected among from various character input boards and which is buriedly inserted to the groove of the body, when a hole of the character input board is partially pressed, inputting an electric signal value which is generated by a corresponding piezoelectric device in the piezoelectric device group, and operating values (character values/figure values/operation values/voice values) corresponding to the electric signal value; and
outputting the values (character values/figure values/operation values/voice values) to a display unit and/or speakers.

8. The method for driving a character learning apparatus as set forth in claim 7, wherein the operation step includes the steps of:
1) determining as to whether a selected character input board is a Korean alphabet plate;
2) if the determination of step a) is positive, storing a value initially inputted from the piezoelectric device group in a register ‘a1’;
3) loading a predetermined value (character value/voice value) corresponding to the value stored in the register ‘a1’ and then storing it in a register ‘a2’;
4) comparing the magnitude of the value stored in register ‘a1’ with that of the value stored in register ‘a2’ and then determining as to whether the comparison value exceeds a limit of error;
5) if the determination of step 4) is positive, outputting corresponding character value and voice value to the display unit and the speakers, respectively, and, if the determination of step 4) is negative, loading a predetermined value for a commercialized voice corresponding to a word of praise and then outputting to the speakers;
6) determining as to whether a second value is inputted from the piezoelectric device group;
7) if the determination of step 6) is positive, storing the second value in a register ‘b1’;
8) determining as to whether the value stored in the register ‘b1’ is in a group in which a value stored in the register ‘a1’ is stored;
9) if the determination of step 8) is negative, loading a predetermined value (character value/voice value) corresponding to the register ‘b1’ and then storing it in a register ‘b2’;
10) comparing the magnitude of the value stored in the register ‘b1’ with that of the value stored in the register ‘b2’ and then determining as to whether the comparison value exceeds a limit of error;
11) if the determination of step 10) is positive, outputting corresponding character value and voice value to the display unit and the speakers, respectively, and, if the determination of step 10) is negative, loading a predetermined value for a commercialized voice corresponding to a word of praise and then outputting it to the speakers;
12) determining as to whether a third value is inputted from the piezoelectric device group;
13) if the determination of step 12) is positive, storing the third value in a register ‘c1’;
14) determining as to whether the value stored in the register ‘c1’ is in a group in which a value stored in the register ‘b1’ is stored;
15) if the determination of step 14) is negative, loading a predetermined value (character value/voice value) corresponding to the register ‘c1’ and then storing it in a register ‘c2’;
16) comparing the magnitude of the value stored in the register ‘c1’ with that of the value stored in the register ‘c2’ and then determining as to whether the comparison value exceeds a limit of error;
17) if the determination of step 16) is positive, outputting corresponding character value and voice value to the display unit and the speakers, respectively, outputting operation values to the display unit and the speakers, respectively, and, if the determination of step 16) is negative, loading a predetermined value for a commercialized voice corresponding to a word of praise and then outputting it to the speakers;
18), based on the determination as to whether a selected character input board is a Korean alphabet plate in step of 1), if the determination of step 1) is negative, further performing a determination as to whether the selected character input board is English alphabet plate;
19) if the determination of step 18 is positive, returning the procedure to the step of 2), such that a value initially inputted from the piezoelectric device group is stored in a register ‘a1’;
20) if the determination of step 18) is negative, further performing a determination as to whether the selected character input board is a figure/operation plate;
21) if the determination of step 20) is positive, returning the procedure to step 2), such that a value initially inputted from the piezoelectric device group is stored in a register ‘a1’;
22) if the determination of step 20) is negative, further performing a de-termination as to whether the selected character input board is an operation plate;
23) if the determination of step 22) is positive, returning the procedure to step 2), such that a value initially inputted from the piezoelectric device group is stored in a register ‘a1’; and
24) if the determination of step 22) is negative, returning the procedure to step 1).
